(19) United States
(12) Patent Application Publication
(10) Pub. No.: US 2012/0318277 A1
(43) Pub. Date: Dec. 20, 2012

(54) BREAST PROTECTIVE SYSTEM AND ORTHOSIS THEREFOR

(76) Inventor: Paul Evans, Mount Waverly (AU)

(21) Appl. No.: 13/255,441

(22) PCT Filed: Mar. 2, 2011
(86) PCT No.: PCT/AU2011/000233

§ 371 Date: Oct. 4, 2011

Related U.S. Application Data
(60) Provisional application No. 61/309,758, filed on Mar. 2, 2010.

(51) Int. Cl. A61G 15/00

(52) U.S. Cl. 128/845

(57) ABSTRACT

An orthosis (protective pad) for placing on a supporting surface to lie adjacent the breasts of a subject lying prone on the surface, the orthosis comprising: (a) a central portion extending along a longitudinal axis of the orthosis to be receivable between the breasts of the subject to support the sternum; and (b) opposed portions extending bilaterally outwardly from a cephalad end of the central portion to support the clavicle and/or upper ribcage/costal cartilage (“cephalad portions”); and/or (c) opposed portions extending bilaterally outwardly from a caudal end of the central portion to support the lower ribcage/costal cartilage and/or upper abdomen (“caudal portions”), the portions being configured such that spaces are defined laterally outward of the longitudinal axis and the breasts are displaced laterally and/or superolaterally to occupy the spaces.

This application is associated with and claims priority from U.S. Provisional Application No. 61/309,758 filed on 2 Mar. 2010 entitled “A protective system and device therefor” the entire contents of which are incorporated herein by reference.

### FIELD

The present invention relates to an orthosis for supporting and positioning the breast and protecting the breast and/or adjacent pain sensitive tissue of a prone subject from unwanted breast compression, displacement, derangement or pain. The orthosis is particularly useful inter alia in a clinical setting such as during clinical examination and/or treatment, during radiological or other procedures, during mastalgia (breast pain), or after masectomy, breast augmentation or reconstruction surgery, or when undertaking physical therapy or massage. The orthosis will also find application for personal use during prone resting outside the clinic such as, without limitation, during mastalgia, or after masectomy, breast augmentation or reconstruction.

### BACKGROUND

Bibliographic details of the publications referred to by author in this specification are collected at the end of the description.

Reference to any prior art in this specification is not, and should not be taken as, an acknowledgment or any form of suggestion that this prior art forms part of the common general knowledge in any country.

Breasts are composed of glandular, fatty, and fibrous tissue positioned over the pectoral muscles of the chest wall to which they are attached by fibrous Cooper's ligaments. Fatty tissue surrounds the breast glands extending throughout the breast giving it a soft consistency.

Face downward resting such as when prone, either in a clinical setting such as during physical therapy or massage, or simply relaxing such as when sunbathing can produce pain and discomfort to the breast tissue through compression and displacement of breast tissue that is sensitive to pain. This problem is exacerbated at times when the breasts are particularly tender or when the anatomical structure has been altered. Breast tenderness (mastalgia, mastodynia or mammalgia) can increase, for example, during menstruation, pregnancy, puberty or breastfeeding, in the presence of mastitis or fibrocystic breast tissue, or as an adverse reaction to medications. Patients post-masectomy with extensive scar tissue experience pain when prone. Patients with breast augmentation report that compression and displacement of breast, scar and implant tissue produces pain when prone. Indeed, such compression or displacement of breast tissue can cause complications such as damage to the implant and/or movement of the implant and damage to adjacent tissue. Correct breast positioning is crucial, for example, to decrease discomfort during mammography or other radiological investigation, and also improves the accuracy of the investigation. Further, chest wall imaging is enhanced if the breast is maintained in a proper position during radiological investigation.

Treatment tables and other devices have previously been produced to address some of these problems by providing direct cushioning or generally breast shaped recesses for breasts. Prior art devices have generally failed to allow successfully for variations in breast position and size and skeletal variations amongst the population. Treatment tables with recesses for breast insertion are disclosed for example in U.S. Pat. No. 7,636,967. Another solution uses an oval pillow with two openings to allow for breast insertion, as disclosed in U.S. Pat. No. 7,426,762. Neither U.S. Pat. No. 7,636,967 nor U.S. Pat. No. 7,426,762 provide superior control of, or protection for, breast tissue.

There is a need in the art for improved systems and devices for protecting and positioning breast tissue of a subject when prone.

### SUMMARY

According to a first aspect of the present invention, there is provided an orthosis (protective pad) for placing on a supporting surface to lie adjacent the breasts of a subject lying prone on the surface, the orthosis comprising: (a) a central portion extending along a longitudinal axis of the orthosis to be receivable between the breasts of the subject to support the sternum; and (b) opposed portions extending bilaterally outwardly from a cephalad end of the central portion to support the clavicle and/or upper ribcage/costal cartilage (“cephalad portions”); and/or (c) opposed portions extending bilaterally outwardly from a caudal end of the central portion to support the lower ribcage/costal cartilage and/or upper abdomen (“caudal portions”), the portions being configured such that spaces are defined laterally outward of the longitudinal axis and the breasts are displaced laterally and/or superolaterally to occupy the spaces.

According to a second aspect of the present invention, there is provided a method of supporting the upper torso of a subject lying prone against a supporting surface, wherein an orthosis as defined herein is positioned between the subject and supporting surface to lie adjacent the breasts of the subject, such that the central portion supports the sternum and the opposed portions support the clavicle and/or upper ribcage/costal cartilage and/or the lower ribcage/costal cartilage and/or upper abdomen, whereby the breasts are displaced laterally and/or superolaterally to occupy the spaces.

Preferably, the orthosis is configured to deform resiliently when engaged by the subject.

Preferably, the orthosis is formed to engage the subject in a cushioning manner.

The orthosis, advantageously will engage the subject in a manner such that regardless of their size there is no circumferential entrapment of the breasts.

Preferably, the central portion is upwardly convex along its length, i.e. as viewed in section orthogonal to the longitudinal axis.

Preferably, the orthosis includes the caudal portions.

Preferably, the caudal portions are integrally formed.

Preferably, each of the caudal portions is upwardly convex as viewed in section orthogonal to an axis along which it contacts the subject.

Preferably, adjacent edge portions of the central and caudal portions form curves which define laterally inner caudal boundaries of the spaces. The edge portions may thus have a curved profile as viewed in section parallel to the supporting surface when the orthosis is placed thereon.

In the preferred embodiments of the invention, a general centre of curvature of each curve is superolateral of a position at which the respective adjacent edge portions meet.

Preferably, the orthosis is configured with a relief between the caudal portions to limit or eliminate pressure on the xiphoid process. Preferably, the relief comprises a concavity formed into an upper surface of the orthosis.

Preferably, the caudal portions are configured to contact the subject along axes which are divergent about the longitudinal axis in a caudal direction. Preferably, each of said axes forms an angle with the longitudinal axis of between about 65° and about 85°. More preferably, each angle is between about 70° and about 80°. More preferably still, each angle is about 75°.

Preferably, the caudal portions are upwardly convex as viewed in section orthogonal to the axes.

Preferably, the orthosis includes the cephalad portions.

Preferably, adjacent edge portions of the central and cephalad portions form curves which define laterally inner cephalad boundaries of the spaces. These adjacent edge portions may thus have a curved profile as viewed in section parallel to the supporting surface when the orthosis is placed thereon.

Preferably, adjacent edge portions of the central and caudal portions form curves which define laterally inner caudal boundaries of the spaces.

Preferably, the cephalad portions are integrally formed.

Preferably, the cephalad portions are upwardly convex.

Preferably, the orthosis is configured with a relief between the cephalad portions to limit or eliminate pressure on the trachea and/or jugular notch to facilitate breathing.

Preferably, the cephalad portions are configured to contact the subject along axes which are divergent about the longitudinal axis in a cephalad direction. Preferably, each of these axes forms an angle with the longitudinal axis of between about 50° and about 70°. More preferably, each angle is between about 55° and about 65°. More preferably still, each angle is about 60°.

Preferably, the cephalad portions are upwardly convex as viewed in section orthogonal to the axes.

Preferably, the orthosis opens bilaterally outwardly of the central portion.

Preferably, the orthosis is of a generally I-shaped configuration.

Preferably, the orthosis is formed from resiliently deformable material.

Preferably, the orthosis is of substantially solid construction.

Preferably, the orthosis is formed with at least one cavity disposed below an exterior surface of the orthosis which is exposed when the orthosis is placed on the supporting surface, to promote deformation of the orthosis.

Preferably, the or each cavity comprises a recess formed into a bottom surface of the orthosis.

Preferably, the or each cavity is arranged under a line along which the orthosis is engaged by the subject.

Preferably, the orthosis includes a said cavity arranged so as to underlie the xiphoid process when the orthosis is engaged by the subject.

Preferably, the orthosis is configured with smoothly curved edge portions which define substantially C-shaped and reverse C-shaped laterally inner boundaries respectively of the spaces.

According to a third aspect of the present invention, there is provided an orthosis as defined above in use.

According to a further description of the present invention, there is provided an orthosis (protective pad) for placing between the breasts of a subject when resting face down on a supporting surface, the orthosis comprising one or more of a central portion extending between the breasts of the subject, an upper (cephalad) portion extending above the breasts from the central portion outwardly toward opposite sides of the subject, and a lower (caudal) portion extending below the breasts from the central portion outwardly toward opposite sides of the subject, wherein either side of the orthosis defines a space between the upper and lower portions to allow the respective breast to displace laterally or superolaterally into said space.

In another description, the present invention provides an orthosis (a protective pad) for placing adjacent to the breasts of a subject when resting face down on a supporting surface, the orthosis comprising at least (a) a central portion extending between the breasts of the subject and either (b) an upper (cephalad) portion extending above the breasts from the position of the central portion outwardly toward opposite sides of the subject and/or (c) a lower (caudal) portion extending below the breasts from the position of the central portion outwardly toward opposite sides of the subject, wherein either side of the orthosis defines a space to allow the breasts to displace laterally and/or superolaterally into said space.

In some embodiments, the orthosis comprises (a) and (b). In other embodiments, the orthosis comprises (a) and (c). In some embodiments, the orthosis comprises (a), (b) and (c).

In some embodiments, the orthosis in use is positioned under the sternum and clavicle and/or upper ribcage/costal cartilage, or alternatively, or in addition, under the lower ribcage/costal cartilage and/or abdomen and wherein the orthosis receives and distributes compression loads away from pain-sensitive breast tissue and onto less pain-sensitive parts of the body adjacent to the orthosis.

Preferably, the orthosis is in the form of a protective pad. Preferably, the orthosis is unitary. Preferably, the orthosis is symmetrical about the longitudinal axis. Preferably, the orthosis is resiliently deformable. Preferably, the orthosis is of molded construction.

The above summary is not and should not be seen in any way as an exhaustive recitation of all embodiments of the present invention.

### BRIEF DESCRIPTION OF THE FIGURES

Some figures contain colour representations or entities. Coloured versions of the figures are available from the Patentee upon request or from an appropriate Patent Office. A fee may be imposed if obtained from a Patent Office.

FIG. 1 is a representation of an illustrative orthosis showing various portions and attributes. The orthosis comprises one or more of portions (i), (ii) and (iii) forming illustrative portion (a); one or more of portions (ii), (iv) and (v) forming illustrative portion (b); and one or more of portions (iii), (vi) and (vii) forming illustrative portion (c). In some embodiments, portions (ii) can be part of portion (a) or (b) and portion (iii) can be part of portion (a) or (c). Thus, in some embodiments, portion (b) (opposed cephalad portions that are generally oriented towards the head of the subject in use) comprises (iv) and (v) while (ii) if present is part of the central portion (a). Similarly, in some embodiments, portion (c) (opposed caudal portions that are generally oriented towards the feet of the subject in use) comprise portions (vi) and (vii) while (iii) if present forms part of the central portion. FIG. 1 also illustrates the longitudinal axis of support (also referred to as a central axis of symmetry) of the orthosis and the laterally inner cephalad and caudal boundaries of the spaces. The lines of engagement indicate how the orthosis is configured, in some embodiments, to contact the subject along axes which are divergent about the longitudinal axis in a caudal (β) or cephalad (α) direction. Shading indicates the contours of the illustrative orthosis, including (1) the substantially upwardly convex configuration as viewed in section orthogonal to lines along which they engage the subject; (2) a relief between the cephalad portions and/or at the cephalad end of the central portions to limit or eliminate pressure on the trachea and/or jugular notch to facilitate breathing; and (3) a relief between the caudal portions and/or at the caudal end of the central portion to limit or eliminate pressure on the xiphoid process.

FIG. 2 is a sketch of an illustrative orthosis illustrating some of the variable dimensions of the orthosis to accommodate anthropometric variations. In addition, the depth and contouring of the orthosis can be varied. The size of the arcs formed by each surface of the orthosis is also variable. Orthoses of varying sizes are illustrated in FIGS. 1, 5 and 6.

FIG. 3 is a photographic representation illustrating the contact and relative positions of the portions of the orthosis on a prone skeleton.

FIG. 4 (FIG. 8 of the provisional specification) is a photographic representation illustrating the contact and relative positions of the portions of the orthosis on a supine skeleton.

FIG. 5 provides photographic representations illustrating three exemplary orthoses (A-C) of the present invention 5A (i) wherein shading in a plan view with cephalad portions (upper or superior end) nearer the top of the sheet illustrates the lines of engagement, upper and lower external relief areas, and other features of the invention; and 5B (ii) in tangential side view with the cephalad portion oriented towards the foot of the sheet, highlighting the inner caudal boundaries (ICuB) and (iii) with the caudal portion oriented towards the foot of the sheet highlighting the inner cephalad boundaries (ICpB). These orthosis were molded from a mineral filled, UV stabilised thermoplastic styrenic rubber modified polypropylene compound that had been oil extended.

FIG. 6 provides photographic representations illustrating (i) three orthoses (A, B and C) of the present invention in a side view with the caudal portion oriented towards the foot of the sheet, and (ii) illustrating an underside of a unitary orthoses in some embodiments of the present invention, comprising hollowed out portions or cavities (indicated by an X) to provide greater deformability adjacent the cavity.

FIG. 7 is a graphical representation of data showing force (N) and pressure (kPa) through breast tissue on spinal manipulation thrust on a subject having natural unaltered breast tissue as described in Example 2. FIG. 7A left hand side provides a three dimensional (3D) pressure image of the right breast at instant of maximum loading in manipulation illustrating the significant maximum pressure experienced by breast tissue without the orthosis. FIG. 7B left hand side provides a 3D image of the breast at instant of maximum force in manipulation illustrating the significantly reduced maximum force reading in the presence of the orthosis. Where the orthosis produced pressure on the sensors these data were excluded from the representations on the right hand side of the Figures. The images represented are a screen dump of the three dimensional pressure image at instant of maximum force as indicated by the spike in the force against time curve (middle graph on right hand side of Figure). The data from the two strips were combined for ease of representation.

FIG. 8 is a graphical representation of data showing force (N) and pressure (kPa) through breast tissue on spinal manipulation thrust a subject LA having silicon breast augmentation as described in Example 2. FIG. 8A provides a pressure image of the right breast at instant of maximum force in manipulation showing the significant maximum force experienced without the orthosis. FIG. 8B illustrates the significantly reduced pressure image of the right breast at instant of maximum force in manipulation in the presence of the orthosis. The edge of the orthosis is represented on the most left hand side of the Figure and the pressure on the orthosis can be seen. Where the orthosis produced pressure on the sensors these data were excluded from the representations on the right hand side of the Figures. The images represented are a screen dump of the three dimensional pressure image at instant of maximum force as indicated by the spike in the force against time curve (middle graph on right hand side of Figure). The data from the two strips were combined for ease of representation.

FIG. 9 is representation of magnetic resonance imaging (MRI) data illustrating reduced anterio-posterior compression (AP) and mesolateral displacement (ML) with and without prone loading in the presence of the orthosis as determined for a subject with natural unaltered breast tissue as described in Example 3. The presence of the orthosis, as shown in the bottom two images, resulted in reduced anterio-posterior compression and reduced mesolateral displacement lying prone compared to the same subject without the presence of the orthosis.

FIG. 10 is a representation of magnetic resonance imaging (MRI) data illustrating graph reduced anterio-posterior compression (AP) and mesolateral displacement (ML) with and without loading in the prone position in the presence of the orthosis for a subject with silicon breast augmentation as described in Example 3. The presence of the orthosis, as shown in the center of the bottom two images resulted in reduced anterio-posterior compression and reduced mesolateral displacement compared to the same subject without the presence of the orthosis.

### DESCRIPTION OF THE INVENTION

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

As used herein the singular forms “a”, “an” and “the” include plural aspects unless the context clearly dictates otherwise. Thus, for example, reference to “an orthosis” includes a single orthosis, as well as two or more orthoses; reference to “an elastomer” includes one elastomer, as well as two or more elastomers; and so forth.

Each embodiment, in this specification is to be applied mutatis mutandis to every other embodiment unless expressly stated otherwise.

The present inventor has developed an orthosis to direct compression and displacement pressures away from pain sensitive breast tissue to more structurally robust tissues including the sternum, clavicle and rib cage. In some embodiments, the orthosis has been adapted to ensure that to the extent that breast tissue is displaced that its displacement is guided by the orthosis and occurs in the most favourable lateral and/or superolateral direction which movement is unimpeded by any part of the orthosis. Preferably, breast tissue is displaced towards the anterior or auxiliary fold.

According to a first aspect of the present invention, there is provided an orthosis (protective pad) for placing on a supporting surface to lie adjacent the breasts of a subject lying prone on the surface, the orthosis comprising: (a) a central portion extending along a longitudinal axis of the orthosis to be receivable between the breasts of the subject to support the sternum; and (b) opposed portions extending bilaterally outwardly from a cephalad end of the central portion to support the clavicle and/or upper ribcage/costal cartilage (“cephalad portions”); and/or (c) opposed portions extending bilaterally outwardly from a caudal end of the central portion to support the lower ribcage/costal cartilage and/or upper abdomen (“caudal portions”), the portions being configured such that spaces are defined laterally outward of the longitudinal axis and the breasts are displaced laterally and/or superolaterally to occupy the spaces.

In some embodiments, the present invention provides an orthosis for placing adjacent the breasts of a subject when resting face down on a supporting surface. In particular, the orthosis is effective in reducing breast tissue compression and/or displacement, or pain associated with breast tissue compression and in improving breast positioning during radiological, surgical or other procedures. In some embodiments, the orthosis sits under at least the body of the sternum where the orthosis receives and distributes compression loads away from pain sensitive breast tissue and onto less pain sensitive parts of the body lying over the orthosis, such as the sternum, abdomen, costal cartilages, ribcage or clavicles. In some embodiments, the lateral sides of the orthosis define a space into which breast tissue may comfortably be displaced during compression. In some embodiments, the degree of breast tissue compression and/or displacement in response to compression loading is reduced relative to the breast tissue compression and/or displacement in the absence of the orthosis.

In some embodiments, the orthosis controls and reduces the compression and/or displacement of breast tissue during prone lying including during clinical examination or physical therapy.

As used herein, the term “adjacent” includes the area above, and/or below and/or between the breast area (breasts).

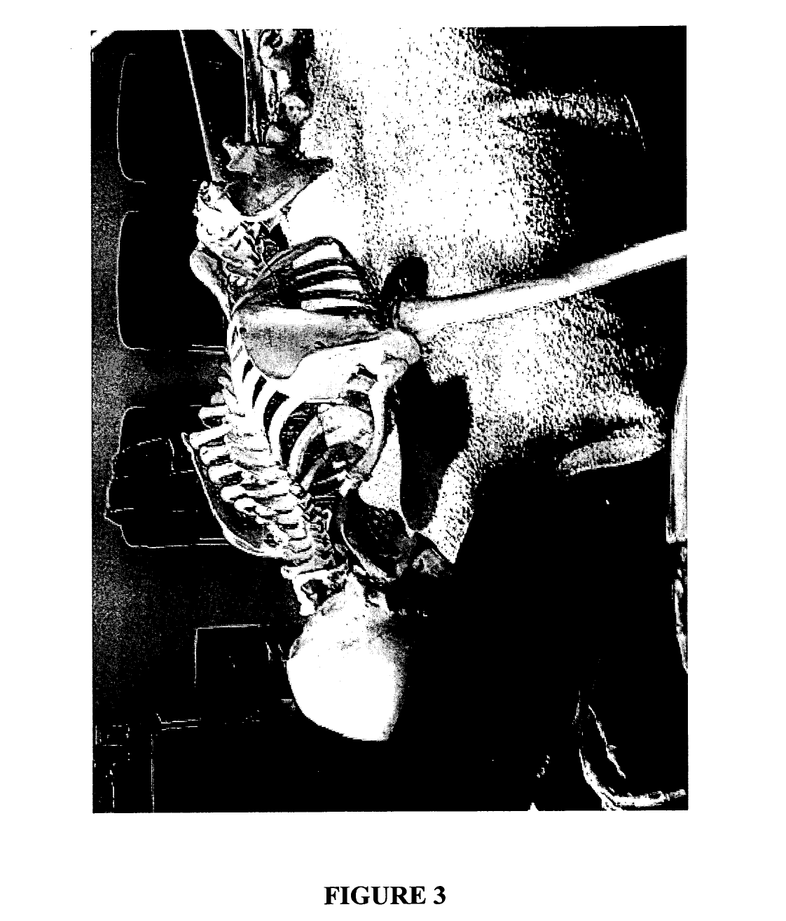

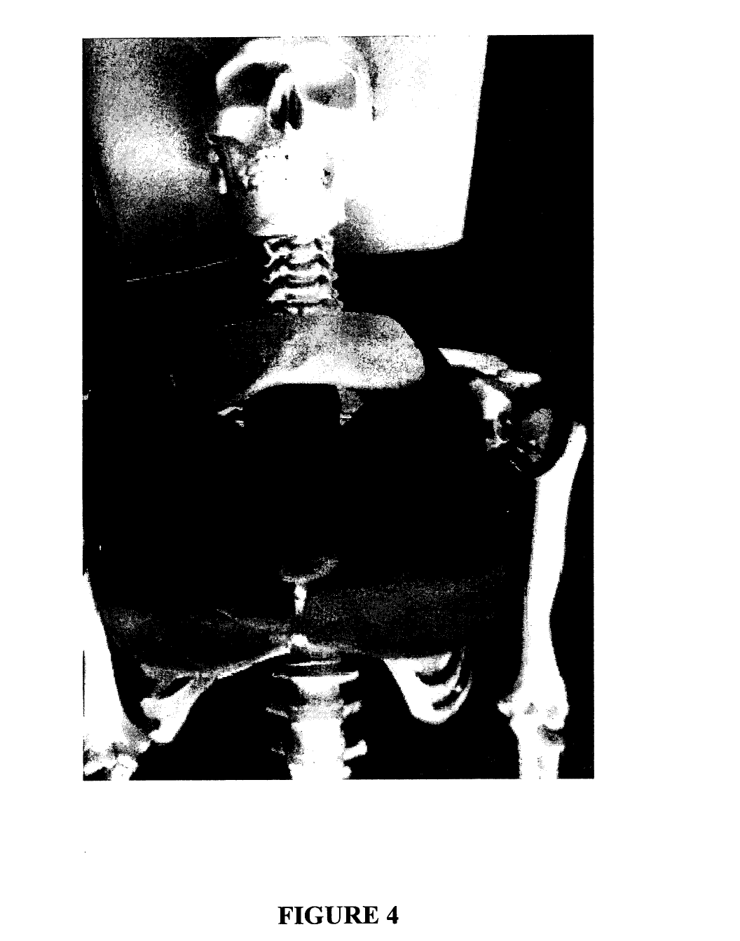

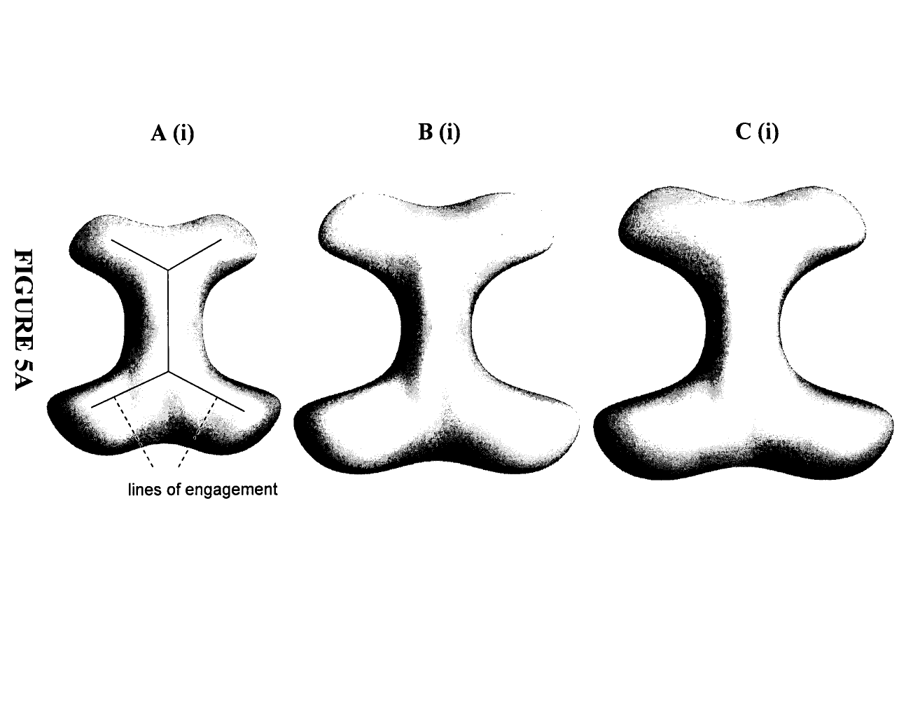

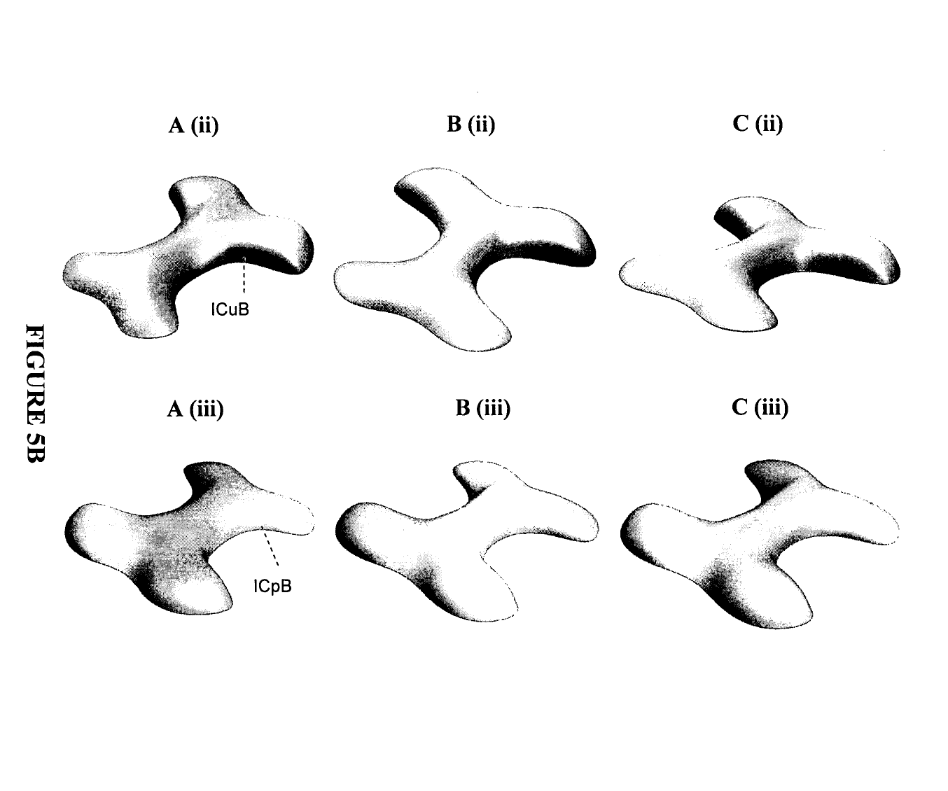

In some embodiments, the orthosis in use is positioned under the sternum and clavicle and/or upper ribcage/costal cartilage, or alternatively, or in addition, under the lower ribcage/costal cartilage and/or abdomen and wherein the orthosis receives and distributes compression loads away from pain-sensitive breast tissue and onto less pain-sensitive parts of the body lying over the orthosis, such as the sternum, abdomen, costal cartilages, ribcage and clavicles. This is illustrated in FIGS. 3 and 4 that show a model of an illustrative orthosis indicating, on a prone or supine skeleton respectively, which areas of the skeleton under which the orthosis is designed to rest in use.

In some embodiments, the orthosis has a central axis of symmetry that in use lines up with the sternum at the midline of the body of the subject.

Compression loads may be derived from the weight of the subject's upper body or from loads applied to the upper body, typically the posterior aspects of the spine or ribcage during, for example, physical therapy or massage. In some embodiments, the orthosis is resiliently deformable.

Without being bound to any particular mode of action, compared with prior art devices for breast positioning during procedures such as radiology, massage, and spinal manipulation, the present invention provides relative ease of use, and a greater capacity for safety, comfort and improved alignment and positioning. In addition, the device allows for good exposure to the axillae and lymphatic system.

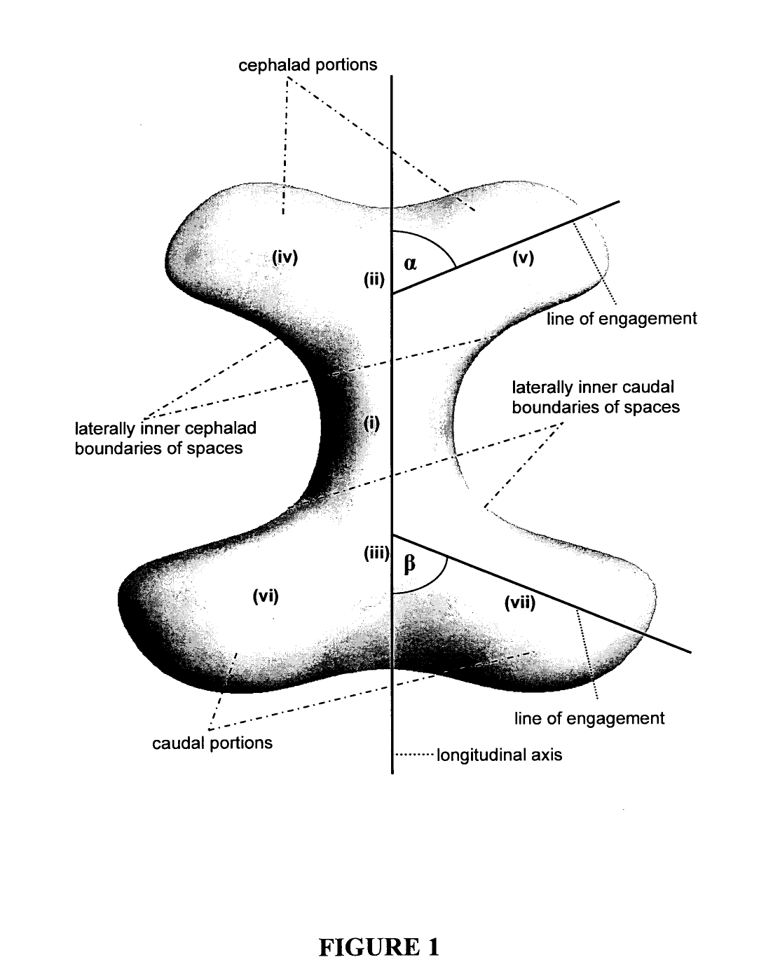

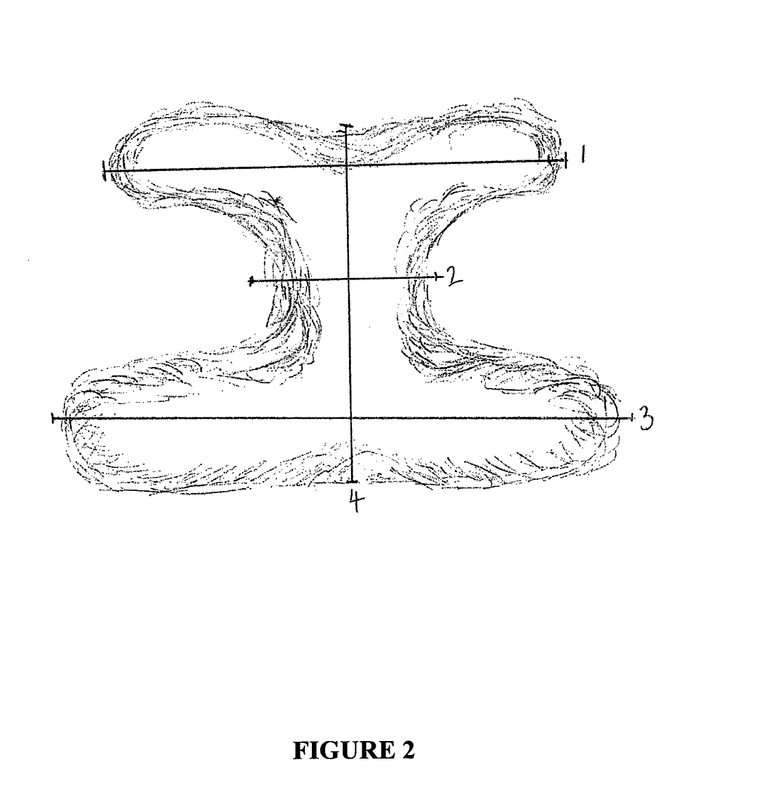

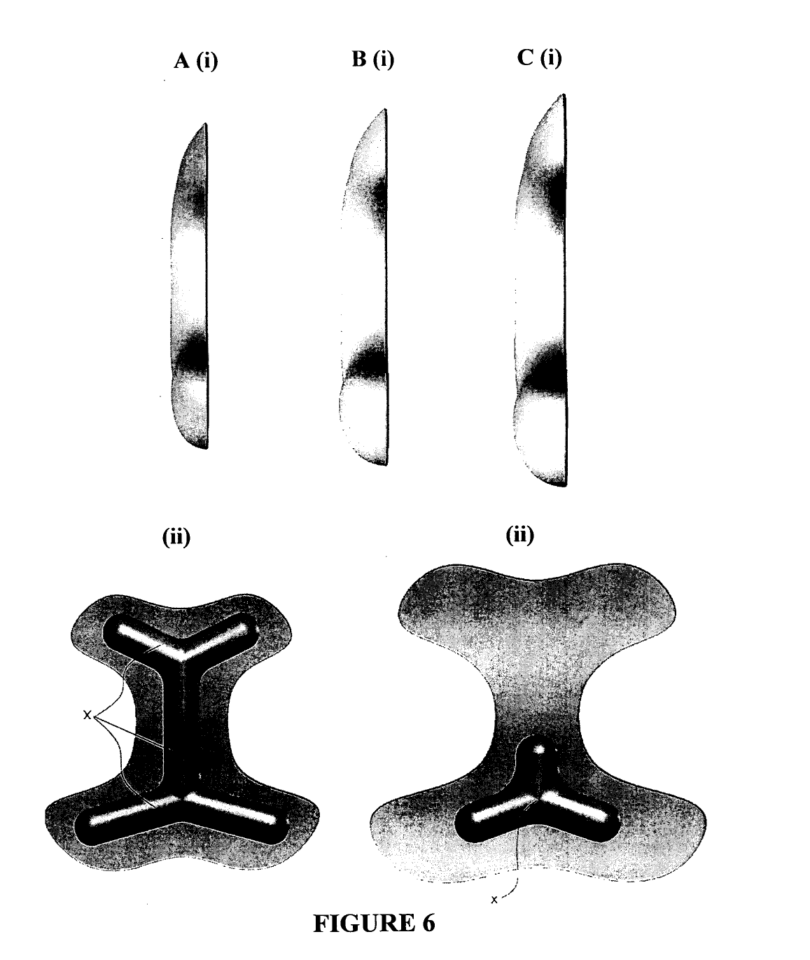

The dimensions of the orthosis and portions are selected, in part, for stability and comfort and to accommodate anthropometric variations in the subject population to ensure that the orthosis distributes compression loads of or on a subject away from breast and adjacent pain sensitive, tissue. Various dimensions of the orthosis may be varied as indicated in FIGS. 1 and 2 illustrated in FIGS. 5 and 6. However, the open-sided, I or C shaped arrangement ensures that whatever their size, breasts are not trapped by a non-customised orthosis.

In some embodiments, the orthosis is contoured for comfort and to avoid pinching of tissue when in use. Accordingly, the orthosis is conveniently shaped so that inter alia at least the breast-facing sides of the orthosis are gently sloped to form smooth contact with breast tissue when in use.

In some embodiments, the orthosis is configured to deform resiliently when engaged by the subject. In other embodiments, the orthosis is formed to engage the subject in a cushioning manner. Advantageously, the orthosis engages the subject in a manner such that whatever their size, that there is no circumferential entrapment of the breasts.

In some embodiments, the central portion is upwardly convex along its length, i.e. as viewed in section orthogonal to the longitudinal axis.

In some embodiments, the orthosis opens bilaterally outwardly of the central portion. In an illustrative embodiment, the orthosis is of a generally I-shaped configuration. In some embodiment, the orthosis is formed from resiliently deformable material. In other embodiments, the orthosis is of substantially solid construction.

In some further embodiments, the orthosis is configured with a relief between the caudal portions to limit or eliminate pressure on the xiphoid process. In some embodiments, the caudal relief comprises a concavity formed into an upper surface (exterior or subject-contacting surface) of the orthosis. In other embodiments, the orthosis is configured with a relief between the cephalad portions to limit or eliminate pressure on the trachea and/or jugular notch to facilitate breathing. In some embodiments, the cephalad relief comprises a concavity formed into an upper (exterior) surface of the orthosis.

In other embodiments, the orthosis is formed with at least one cavity disposed below an exterior surface of the orthosis which is exposed when the orthosis is placed on the supporting surface, to promote deformation of the orthosis. In some embodiments, the or each cavity comprises a recess formed into a bottom surface of the orthosis. In some embodiments, the or each cavity is arranged under a line along which the orthosis is engaged by the subject. In some embodiments, the orthosis includes a said cavity arranged so as to underlie the xiphoid process when the orthosis is engaged by the subject.

In some embodiment, the orthosis is configured with smoothly curved edge portions which define substantially C-shaped and reverse C-shaped laterally inner boundaries respectively of the spaces.

In a preferred embodiment, the orthosis includes the caudal portions. In some embodiments, these are integrally formed.

In an exemplary embodiment, each of the caudal portions is upwardly convex as viewed in section orthogonal to an axis along which it contacts the subject.

In another exemplary embodiment, adjacent edge portions of the central and caudal portions form curves which define laterally inner caudal boundaries of the spaces. These are illustrated in the Figures (See FIG. 1). The edge portions may thus have a curved profile as viewed in section parallel to the supporting surface when the orthosis is placed thereon. In some embodiments of the invention, a general centre of curvature of each curve is superolateral of a position at which the respective adjacent edge portions meet.

In an illustrative embodiment, the caudal portions are configured to contact the subject along axes which are divergent about the longitudinal axis in a caudal direction. In some embodiments, each of said axes forms an angle (see FIG. 1 angle marked β) with the longitudinal axis of between about 65° and about 85°. In some embodiments, each angle is between about 70° and about 80°. In still further embodiment, each angle is about 75°.

In some embodiments, the orthosis includes the cephalad portions.

In an illustrative embodiment, adjacent edge portions of the central and cephalad portions form curves which define laterally inner cephalad boundaries of the spaces. These adjacent edge portions may thus have a curved profile as viewed in section parallel to the supporting surface when the orthosis is placed thereon. In some embodiment, adjacent edge portions of the central and caudal portions form curves which define laterally inner caudal boundaries of the spaces.

In some embodiments, the cephalad portions are integrally formed. In other embodiments, the cephalad portions are upwardly convex as viewed in section orthogonal to the axes.

Preferably, the cephalad portions are configured to contact the subject along axes which are divergent about the longitudinal axis in a cephalad direction. Preferably, each of these axes forms an angle (see FIG. 1 angle marked a) with the longitudinal axis of between about 50° and about 70°. More preferably, each angle is between about 55° and about 65°. More preferably still, each angle is about 60°.

In another descriptions, the present invention provides an orthosis for placing adjacent the breasts of a subject when resting face down on a supporting surface, the orthosis comprising one or more of the following portions: (a) a central portion extending between the breasts of the subject; (b) an upper portion extending above the breasts from the central portion outwardly toward opposite sides of the subject; and (c) a lower portion extending below the breasts from the central portion outwardly toward opposite sides of the subject, wherein the breast-facing sides of the orthosis define spaces to allow each breast to displace laterally or superolaterally into said space.

In some embodiments, the orthosis comprises (a) and (c) and/or (b). The lower caudal portion(s) are particularly important for distributing breast tissue outwardly. Thus, in some embodiments, the upper cephalad portion(s) is absent.

In some embodiments, the orthosis comprises (a), (b) and (c) as described herein and as illustrated in FIGS. 1, FIG. 5 and FIG. 6.

In another embodiment, the present invention provides an orthosis for placing between the breasts of a subject when resting face down on a supporting surface, the orthosis comprising a central portion extending between the breasts of the subject, an upper portion extending above the breasts from the central portion outwardly toward opposite sides of the subject, and a lower portion extending below the breasts from the central portion outwardly toward opposite sides of the subject, wherein either side of the orthosis defines a space between the upper and lower portions to allow the respective breast to, displace laterally or superolaterally into said space.

The term “portion” includes any part of a unitary orthosis (pad) and thus describes a region of orthosis. The term further describes a discrete part of an orthosis that is manufactured as a discrete pad and used separately or together with other pads. Any number of discrete portions may be employed depending upon the demands of the situation.

In some embodiments, the orthosis is unitary.

In some embodiments, the orthosis has a central axis of symmetry extending, in use, between the breasts of the subject.

In one particular but non-essential embodiment, the orthosis is resiliently deformable.

Conveniently, the orthosis is fabricated such as, without limitation, molded from resiliently deformable material or one or more precursors thereof. It is proposed that a resiliently deformable material is adapted to transmit compression forces onto less pain sensitive orthosis contact surfaces. In some embodiments, the orthosis is fabricated having an inner deformable material and an outer casing. Filled or fellable bladders are included in this aspect. Bladders may be filled with air, gaseous mixtures, gels, liquids or semi-solid material and the like.

As known in the art, the sternum is an elongate flattened bone that forms the middle portion of the anterior wall of the thorax. Its anterior end supports the clavicle and its margins articulate with the costal cartilage of the first seven pairs of ribs. It consists of three parts: most superiorly the “manubrium” which has a quadrangular shape narrowing to meet a long thin “body”, and the most inferior “xiphoid process”.

The costal cartilages are bars of hyaline-rich cartilage that provide considerable elasticity to the walls of the thorax. The lateral side of each cartilage is continuous with the rib bone. In older subjects, there is a tendency for at least the surface of the costal cartilage to undergo ossification.

In a further description, the present invention provides an orthosis (protective pad) for placing adjacent to the breast area of a subject when resting face down on a supporting surface, the orthosis comprising one or more of the following portions: (a) a central sternum portion that rests on the supporting surface and extends upwardly toward the sternum of the subject and which extends axially along the midline between breasts; (b) an upper clavicle portion that rests on the supporting surface and extends upwardly towards the subject above (cephalad/superior to) the central sternum portion to contact (support) the subject at the region of the clavicle and/or upper ribcage/costal cartilage above the breasts; and (c) a lower ribcage portion that rests on the supporting surface and extends upwardly towards the subject below (caudal/posterior to) the central sternum portion to contact (support) the subject at the region of the lower ribcage/costal cartilage and/or abdomen below the breasts.

In some embodiments, either side of the orthosis defines a space between the upper and lower portions to allow the respective breast to displace laterally or superolaterally into said space.

Each orthosis may be manufactured as two or more separate portions for use separately or together.

In another aspect, the present invention provides an orthosis for placing adjacent the breast of a subject when resting face down on a supporting surface, the orthosis comprising: (a) a central sternum portion that rests on the supporting surface and extends upwardly toward (to support) the sternum of the subject and which extends axially along the midline between breasts; and (b) an upper clavicle portion that rests on the supporting surface and extends upwardly towards the subject above the central portion to contact (support) the clavicle and/or upper ribcage/costal cartilage above the breasts; and (c) a lower ribcage portion that rests on the supporting surface and extends upwardly towards the subject below the central sternum portion to contact (support) the lower ribcage/costal cartilage and/or abdomen below the breasts.

In some embodiments, the orthosis or portion thereof has an approximately rectangular base and lateral sides for facing breast tissue having a rounded, semi-circular axial cross section, tapered at the base. In some embodiments, the base is flat. In other embodiments of the invention, the base is generally concave.

In some embodiments, portion (a) extends along at least the length of the body of the sternum.

In some embodiments, portion (a) extends along the length of the body of the sternum and under the length of manubrium.

In some embodiments, portion (a) and/or (c) avoid contact with the xiphoid process such as wherein the orthosis terminates above the process or by tapering (providing a relief to) the orthosis in this region.

In some embodiments, portion (c) extends over the lower ribcage/costal cartilage.

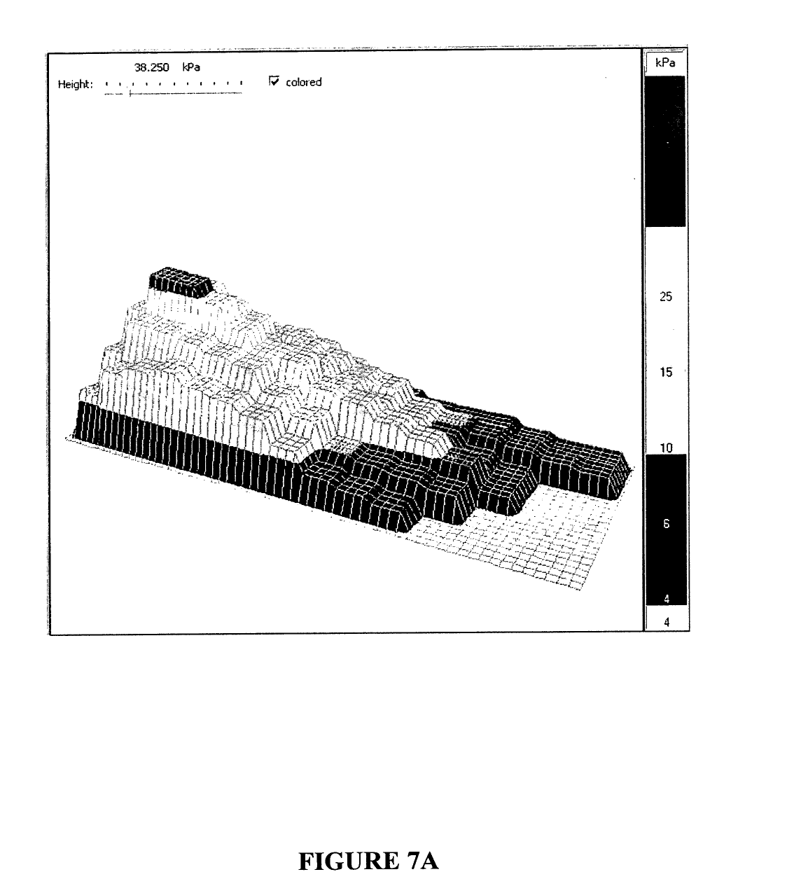

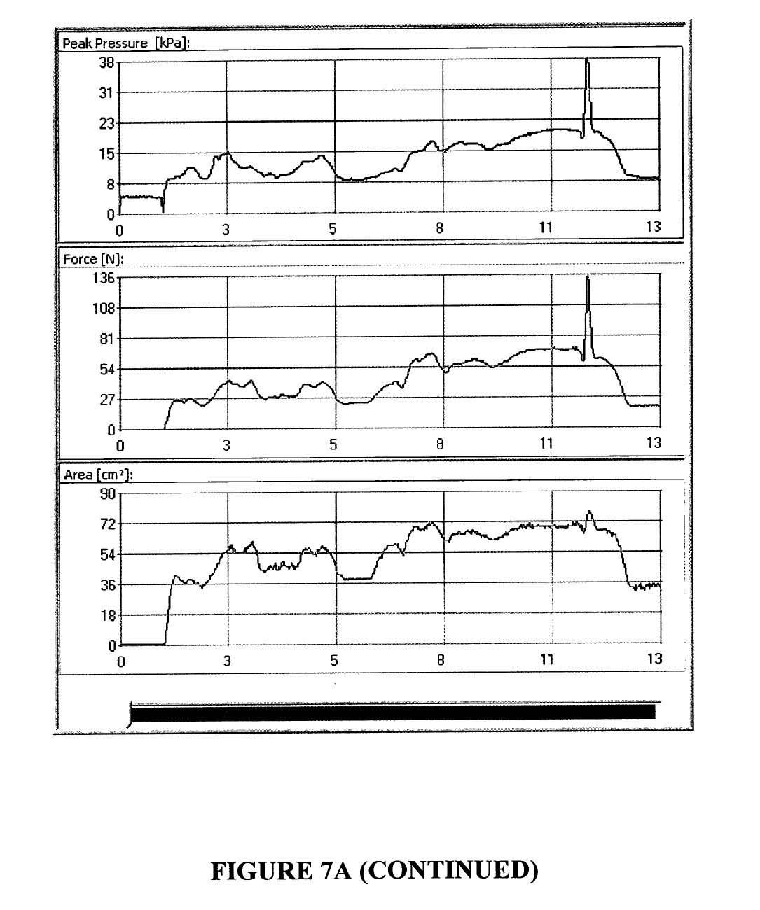

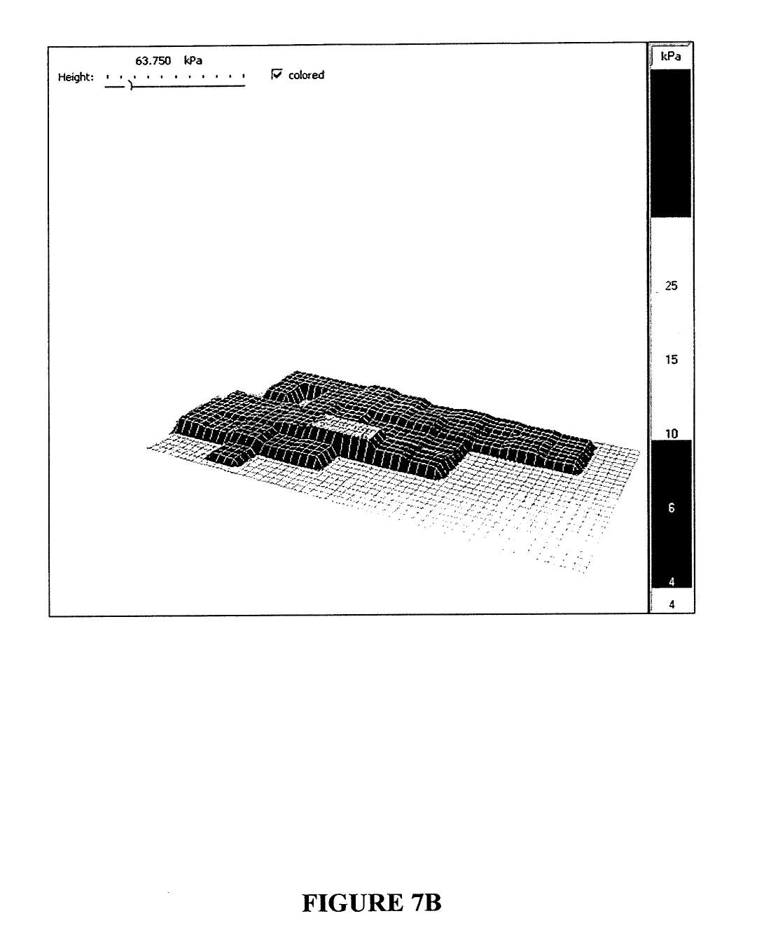

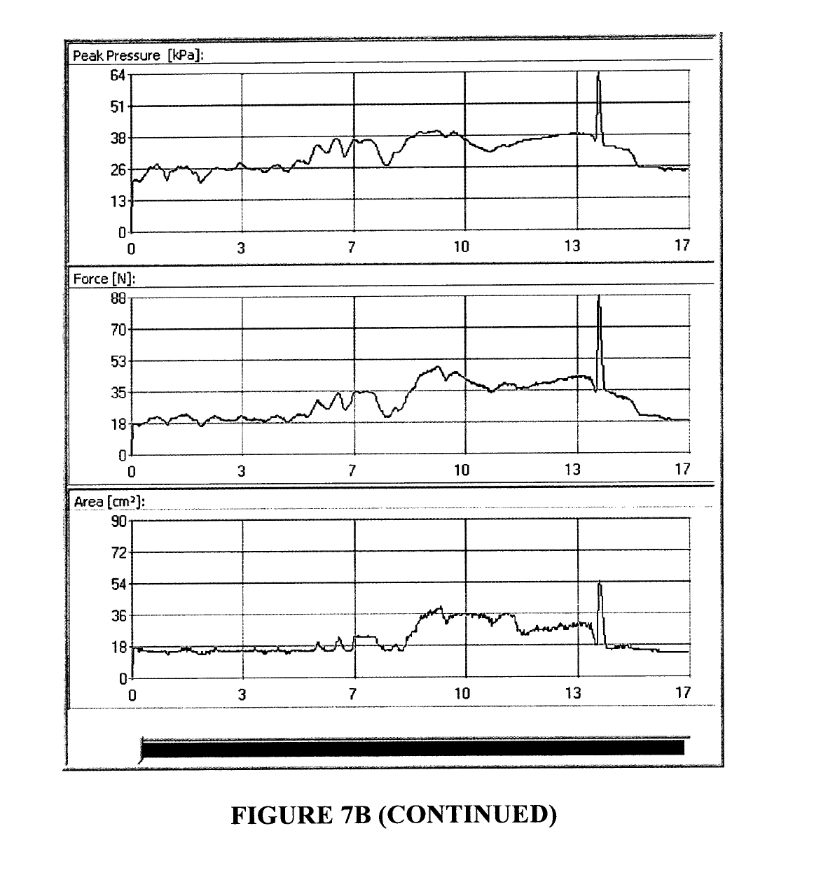

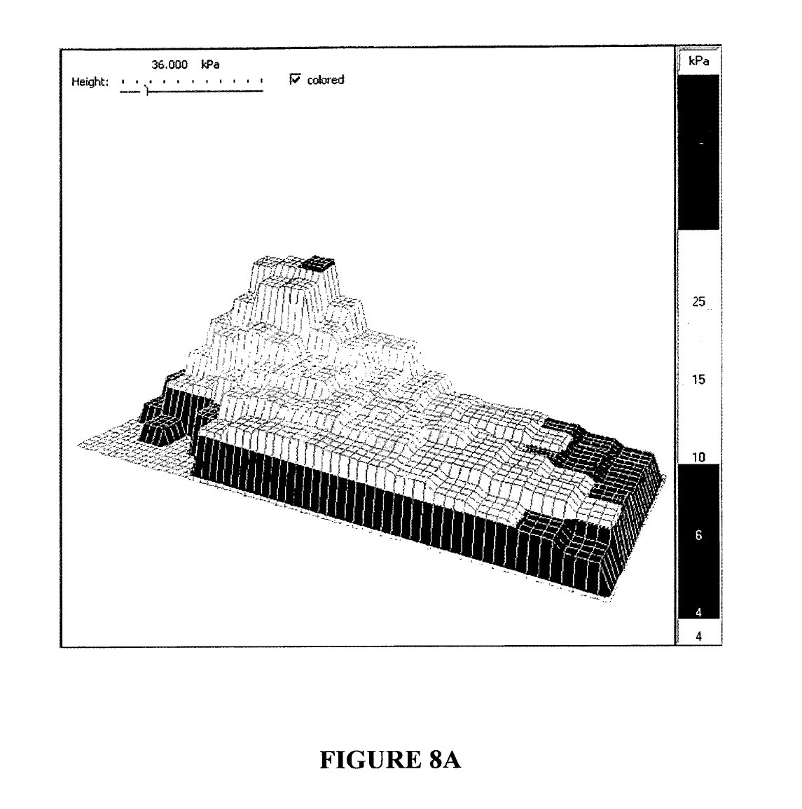

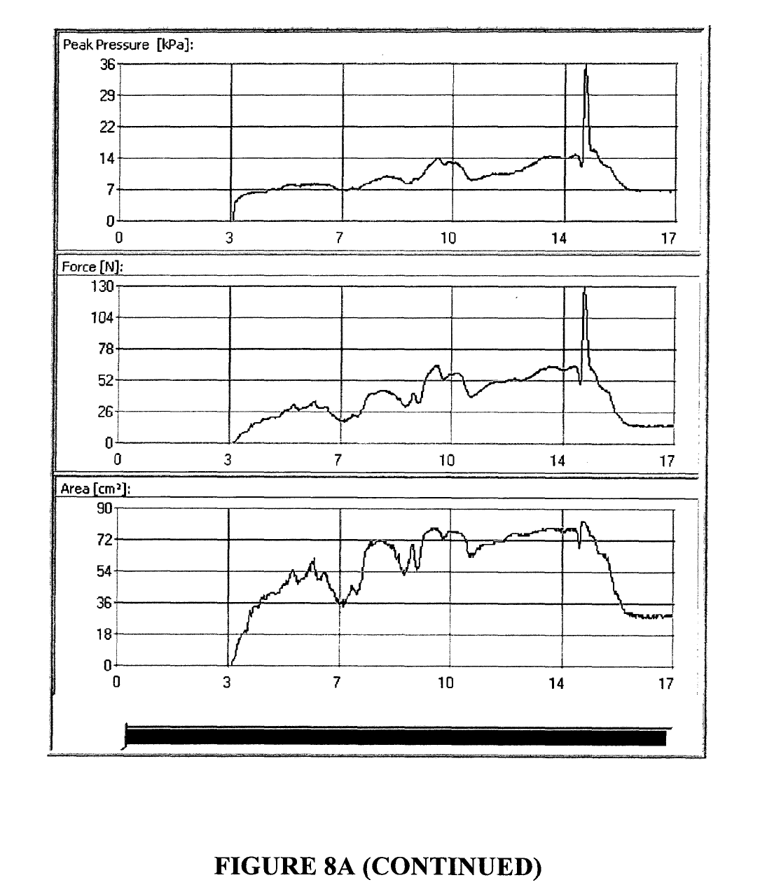

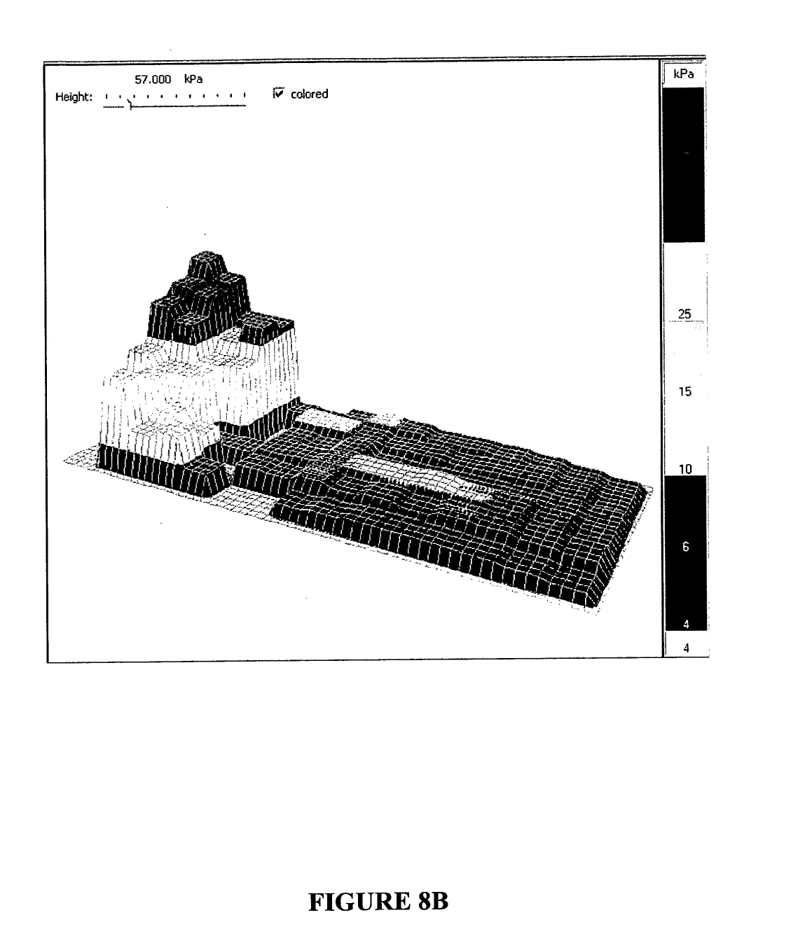

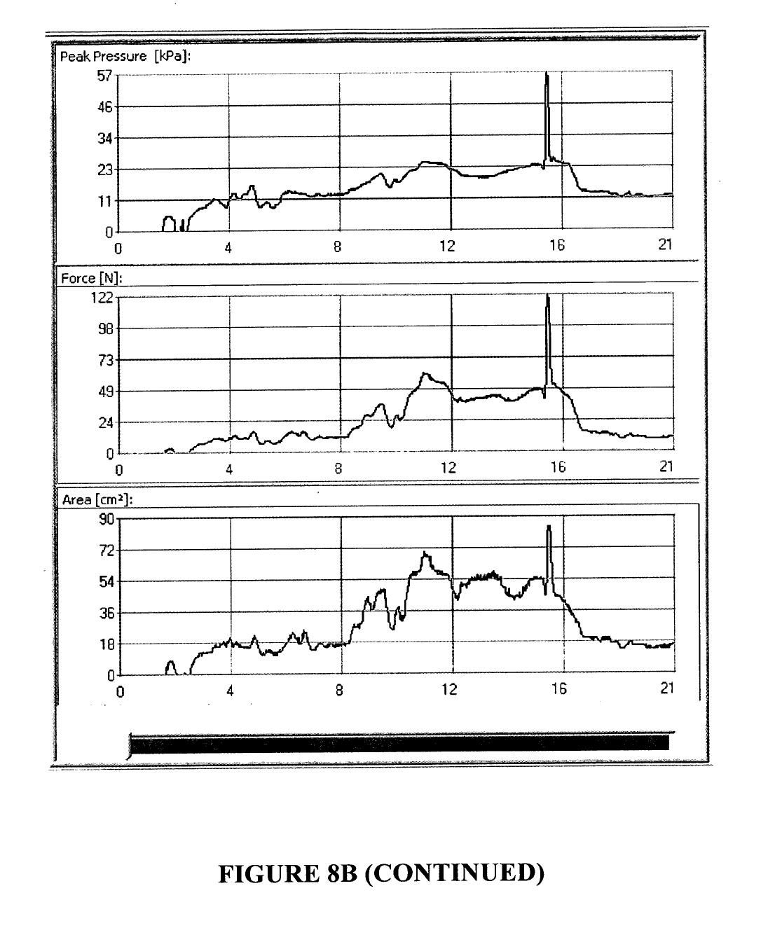

This is illustrated in FIG. 1(C), FIG. 7 and FIG. 8 of the provisional specification. Here, the pad portion C comprises portion (iii) and further comprises portions (vi) and (vii) as depicted in FIG. 1.

In other illustrative embodiments, see FIGS. 4 to 7 of the provisional specification, the central sternum portion (a) comprises portions (i) and (ii) as shown in FIG. 1 and the lower ribcage/costal cartilage portion comprises two portions that join or overlap under the central sternum portion as shown in FIGS. 4 to 7.

In some embodiments, portion (b) extends over the clavicle. This is illustrated in FIG. 1(B). Here, the pad comprising portion (ii) further comprises portion (iv) and (v).

Accordingly, generally the precise boundaries and subportion compositions of each portion as described herein are flexible to allow for minor variations in the arrangement of the device without substantially altering its functional activity

In some embodiments, portion (b) extends over the clavicle.

In some embodiments, the depth of the orthosis is substantially uniform axially along the sternum portion. In some embodiments, the orthosis manufactured as a single unit.

In other embodiments, the portions of the orthosis are manufactured as separate units and used either separately or together. In some embodiments, a portion may be further subdivided and manufactured as a separate unit to be combined in use. A single (unitary) device is illustrated in the Figures illustrating orthoses of the present invention having sternum/central, clavicle/upper/cephalad and lower/lower ribcage/caudal portions for distributing loading pressure away from pressure sensitive breast and adjacent tissues.

In some embodiments, the upper and lower portions of the orthosis are only inter-connected via the central portion. In some embodiments, two or three or more separate portions or subportions of an orthosis are detachably inter-connected.

In a particular embodiment, the orthosis is open-sided to allow for lateral displacement of breast tissue. In a further embodiment, unimpeded lateral displacement towards the anterior or auxiliary folds is provided. In some embodiments, each portion of the orthosis is adapted to distribute breast tissue laterally or superolaterally and to distribute compression loads away from breast tissue and on to musculo-skeletal structure adjacent to each portion, when in use.

In some embodiments, one or more orthoses and/or any number of portions thereof optionally in various dimensions are sold as a kit optionally with instructions for use.

According to a second aspect of the present invention, there is provided a method of supporting the upper torso of a subject lying prone against a supporting surface, wherein an orthosis as defined herein is positioned between the subject and supporting surface to lie adjacent the breasts of the subject, such that the central portion supports the sternum and the opposed portions, support the clavicle and/or upper ribcage/costal cartilage and/or the lower ribcage/costal cartilage and/or upper abdomen, whereby the breasts are displaced laterally and/or superolaterally to occupy the spaces.

The orthosis is adapted to reduce the applied force to breast tissues during prone lying including the compression and displacement of breast and adjacent tissue.

The present invention provides a system for positioning or protecting pain sensitive breast tissue of a subject such as from compression loads during face-down lying on a supporting surface, the method comprising providing an orthosis as defined herein for positioning adjacent to breasts to ensure that compression and/or displacement loads are distributed to less pain sensitive areas lying above the orthosis, wherein the orthosis comprises one or more of (a) a central sternum portion that rests on the supporting surface and extends upwardly toward the sternum of the subject and which extends axially along the midline between breasts; (b) an upper clavicle portion that rests on the supporting surface and extends upwardly towards the subject above the central portion to contact the clavicle and/or upper ribcage/costal cartilage above the breasts; and (c) a lower ribcage portion that rests on the supporting surface and extends upwardly towards the subject below the central portion to contact the lower ribcage/costal cartilage and/or abdomen below the breasts.

In some embodiments, the system is for use during radiological or other procedure involving the breasts, such as during mammography or chest imaging. The system comprises selecting an orthosis or portions thereof, suitable for a particular subject. Given the open side arrangement each orthosis will be suitable for a wide range of subject sizes.

In some embodiments, the orthosis comprises portion (a), portion (b) and portion (c) as a single unit or as separate portions. In some embodiments, the orthosis comprises (a) alone; (b) alone or (c) alone and each of these portions may be unitary or as separate parts or portions (sub-portions). In some embodiments, portions (a) and (b), (a) and (c), or (b) and (c) are separate portions or in the case of (a) and (b) or (a) and (c), unitary.

Thus, the orthosis may be unitary or comprised of portions which may be positioned contiguously or in an overlapping fashion.

As described herein, when exposed to compressive loads such as when prone lying or during spinal manipulation thrust the degree of breast tissue compression and displacement is substantially reduced in the presence of the subject orthosis. This includes breast tissue that is natural or breast tissue that has been augmented with implants such as silicon and saline implants.

In some embodiments, the orthosis reduces displacement including mesolateral displacement and/or compression including anterior-posterior compression by at least about 50% in subjects with natural unaltered breast tissue and at least 10% in a subject with an implant. As shown in the illustrative Examples, the orthosis reduces the maximum force through the breast on spinal manipulation thrust by at least 50% compared to the maximum force through the breast without the presence of the orthosis.

In some embodiments, displacement is reduced by at least about 55%, 60%, 65%, 70%, 75% or 80% in the presence of the orthosis compared to displacement without the orthosis.

In some embodiments, compression is reduced by at least about 55%, 60%, 65%, 70%, 75% or 80% in the presence of the orthosis compared to displacement without the orthosis.

In some embodiments, displacement is reduced by at least about 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, or 40% in subjects with an implant.

In some embodiments, compression is reduced by at least about 11%, 12%, 13%, 14%, 15%, 16%, 17%, 18%, 19%, at least 20%, 21%, 22%, 23%, 24%, 25%, 26%, 27%, 28%, 29%, 30%, 31%, 32%, 33%, 34%, 35%, 36%, 37%, 38%, 39%, 40% in subjects with an implant.

In some embodiments, the maximum force on the breast is reduced by at least about 55%, 65%, 70%, 75%, 80%, 85%, 90 or 95% relative to the maximum force through the breast without the orthosis.

The deformable, resilient material from which the orthosis may be made is selected from any one or more suitable compositions including without limitation a natural or synthetic elastomeric material. The orthosis may comprise a gas, a liquid, a gel, an emulsion, a solid, a particulate material (including, for example, sand, soil, beads, microspheres, grains, dried organic matter such as beans, pulses, rice, grains, seeds, fruits, and vegetables), a polymeric, monomeric or hybrid colloidal material, or any combinations of these. In some embodiments, reinforcing and/or coating material is employed which may be removable.

In some embodiments, the orthosis is an elastomer composition. In accordance with this aspect of the invention, any elastomeric composition having suitable deformability and resilience to distribute compression load as described herein may be employed in the subject orthosis.

In some embodiments, the elastomer is a thermoplastic or thermoset elastomeric polymer or co-polymer. In some embodiments, the orthosis comprises or consists of a rubber modified polypropylene such as a mineral filled, UV stabilised thermoplastic styrenic rubber modified polypropylene compound that has been oil extended.

Suitable compositions are known to those of skill in the field of polymeric materials. These include those formed from natural latex, isoprenes, polyisoprenes, polystyrene butadienes, nitrile elastomers, butyl elastomers, ethylene propylene terpolymers, silicone elastomers, neoprenes, polysulfide, poly acetyl, eperchloride, fluoroelastomers, hypalon, halogenated butyl, polyurethanes, and thermoplastic elastomers.

The majority of synthetic rubbers are derived from petroleum, coal, oil, natural gas, and acetylene. Suitable compositions and methods of making them are known to those of skill in the field of polymers and plastics. Illustrative polymers are described in Charrier, Jean-Michel, Polymeric Materials and Processing: Plastics, Elastomer, and Composites, Oxford University Press, USA, 1991 and Gent, Alan N. (Ed), Engineering With Rubber: How to Design Rubber Portions, 2nd Edition, Editor, Hanser Gardner Publications, 2001.

Polyurethane elastomers (spandex) are made from urethane (for strength) and polyether or polyester (for elasticity). They are versatile elastomers because of their hardness, strength and oil resistance. They are widely used for making foam for bedding. Nitrile elastomers are co-polymers of acrylonitrile and a diene, such as butadiene. Neoprene (polychloroprene) is useful for heavy-duty applications. Butyl elastomers are co-polymers of isobutylene and isoprene (1.3%). These are typically used to make injection models and extruded products where good shock absorption is required. They are also resistant to abrasion. Styrene-butadiene co-polymers (BunaS and SBR) are formed by emulsion polymerisation of butadiene and styrene in various ratios, cis-polybutadiene and cis-polyisoprene. Polymers are also usefully employed.

Ethylene-propylene co-polymers are similar to SBR. They are often used for car parts and footwear. Silicone elastomers are polymers of dimethysilanediol. Polysulfide, sulfide and polyacrylate elastomers have valuable characteristics. These are used in inter alia medical implants.

The orthoses and portions thereof are manufactured in various sizes to accommodate anthropometric variation. Generally, orthoses and portions are manufactured having a depth at the deepest point (the point of contact with the sternum) of between about 1 cm and about 20 cm, although orthoses of greater or less depth are not excluded.

Kits are contemplated comprising plural orthoses (such as A, B and C illustrated in FIG. 5) and/or portions thereof to suit the majority or a subset of subjects dependent upon the dimensions or average dimensions of the thorax (including ribcage, clavicle, sternum) and breast tissue (typically characterised by bra cup size). Thus, orthoses and portions are manufactured to suit subjects with bra cup sizes from A to G and above. In some embodiments, the device is customised to fit a particular subject.

Detachable connectors between portions are contemplated. Suitable connectors include, without limitation, a cooperative latching arrangement configured between portions (e.g. Velcro), or a male-female type attachment arrangement attached to or within the orthosis portions (e.g. snap connection), a magnetic fastener arrangement and the like. Detachable connectors may themselves be detachable and may be sold separately or together as part of the subject kits.

The present invention is further described by the following non-limiting Examples and Figures.

### Example 1

### Illustrative Materials

In an illustrative embodiment the orthosis comprises a mineral filled, UV stabilised thermoplastic styrenic rubber modified polypropylene compound that has been oil extended. The compound has a low flow grade suitable for extrusion, whilst it is shear thinning and has good mould filling capability for mould filling injection moulding applications. The compound was developed for maximum flexibility and low surface hardness to provide “soft-feel” characteristics. The orthoses have been made in three different sizes A, B and C to accommodate all different sized subjects.

The physical properties of elastomeric pads can be assessed in the following tests: Indentation Force Deflection (IFD), Compression Load Deflection (CLD), % Compression Set, Tensile Strength, Elongation Strength, Tear Strength, Impact Resilience, Clickability, Weldability, Aging, and/or Fatigue (such as Fatigue, Roller and Constant Force Pounding Fatigue). Illustrative characteristics include: Specific Gravity 0.91; Melt Flow Index 2.2; Tensile @ 100% Strain 0.3; Tensile @ 300% Strain 0.7; Ultimate Tensile Strength 1.6; Durometer A-17; Tear Strength-8. Such characteristics may be varied and depending upon the contingencies of the situation remain within the scope of the invention. Reference may be made to Charrier, Jean-Michel, Polymeric Materials and Processing: Plastics, Elastomer, and Composites, Oxford University Press, USA, 1991 and Gent, Alan N. (Ed), Engineering With Rubber: How to Design Rubber Portions, 2nd Edition, Editor, Hanser Gardner Publications, 2001.

The material may be processed on most conventional types of extruder used for sheet or profile extrusion, however multi-stage or twin screw with vacuum venting is recommended. The processing temperatures should be in the range of 160-180° C. with die temperatures in the range of 160-180° C. These compounds are subject to reduction in viscosity if used with high shear screws, thus reducing the melt strength. The melt temperature should be as close as possible to die temperatures to ensure good calliper control. Pre-drying is not normally required, however after long storage periods or in humid conditions, pre-drying for about 1-2 hours at approximately 60° C. may be advisable.

### Example 2

### The Device Provides Reduced Loading Through Breast Tissue on Lying Prone, Spinal Manipulation Thrust and During Weight Loading as Determined by Pressure Testing

Trials were conducted to determine the ability of the orthosis as defined herein and as illustrated in the Figures to relieve pressure to the breast during prone lying and during prone loading. Pressure testing was conducted by Dr Patrick McLaughlin, School of Biomedical and Health Services, Victoria University, Melbourne, Australia. Women having bra cup sizes from C to EE, either naturally or augmented with silicon, were assessed during prone lying on a supporting surface having capacitance sensors under the right breast either in presence or absence of the device. Two strips, comprising 3 groups of 15 capacitance sensors each group having an area of 1 cm² were positioned under the right breast, sensors were sensitive to 4 kPa and had a sample rate of 50 Hz. Maximum force (N) and peak pressure (kPa) readings were taken for each subject in the presence and absence of the orthosis (i) during no external applied force, (ii) during loading with a 15 Kg weight placed on the back over the breast area, (iii) during exposure to a spinal manipulation thrust by an osteopath to the spine above (when prone) the breast area (not all subjects).

The results for each subject are tabulated in Table 1. There was an at least approximately 50% reduction in maximum force in the presence of the orthosis for all subjects. Subject C, having CC cupsize with natural unaltered breast tissue displayed an 80% reduction in force through the breast on spinal manipulation in the presence of the orthosis and a 95% reduction in force with 15 Kg loading in the presence of the orthosis (See FIG. 7A without the orthosis and FIG. 7B with the orthosis). Subject LA, having EE cupsize with silicon implant exhibited a 65% reduction in force through breast on spinal manipulation in the presence of the orthosis and an 86% reduction in force experienced with loading in the presence of the orthosis (see FIG. 8A without the orthosis and FIG. 8B with the orthosis indicating reduced pressure on the breast tissue).

### Example 3

### Subjects Exhibit a Reduction in Anterio-Posterior Compression (AP) and Mesolateral Displacement (ML) During Loading in the Presence of Device as Determined by Magnetic Resonance Imaging (MRI)

Women having bra cup sizes from C to EE, either naturally or augmented with silicon (as for Example 2) were assessed by MRI during prone lying on a supporting surface. MRI images of breast tissue were obtained for each subject in the presence and absence of the orthosis (i) during no external applied force, and (ii) during loading with a 15 Kg weight placed on the back over the breast area. The extent of AP compression and ML displacement under these conditions was determined instrumentally directly from the image data.

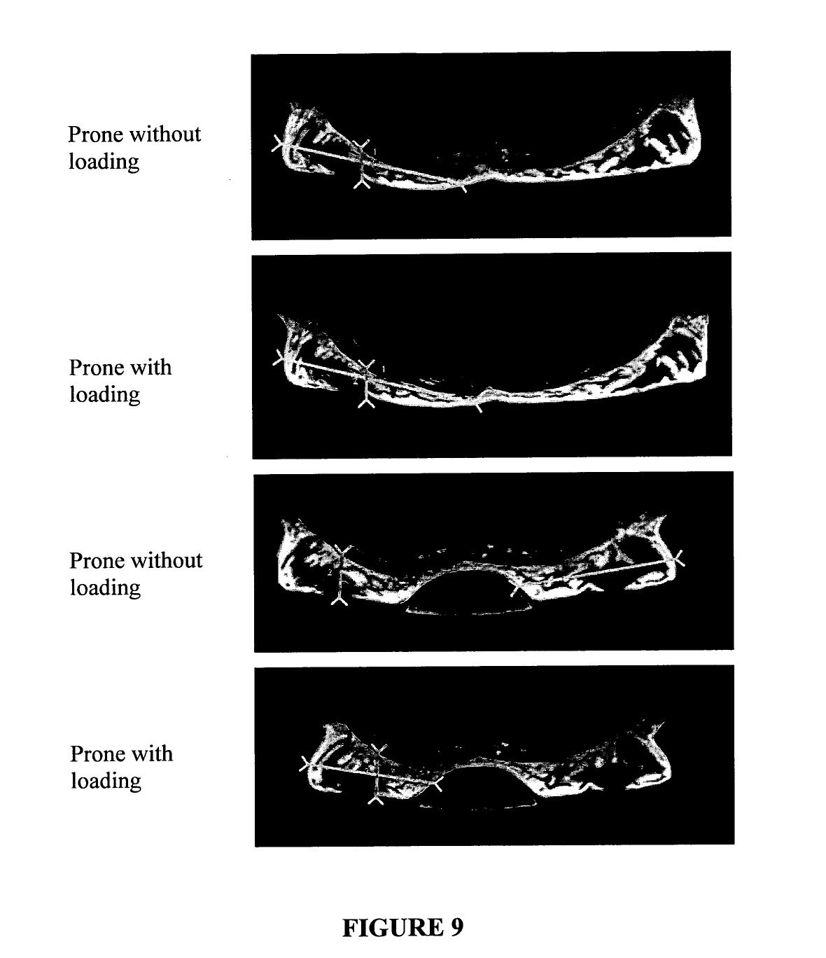

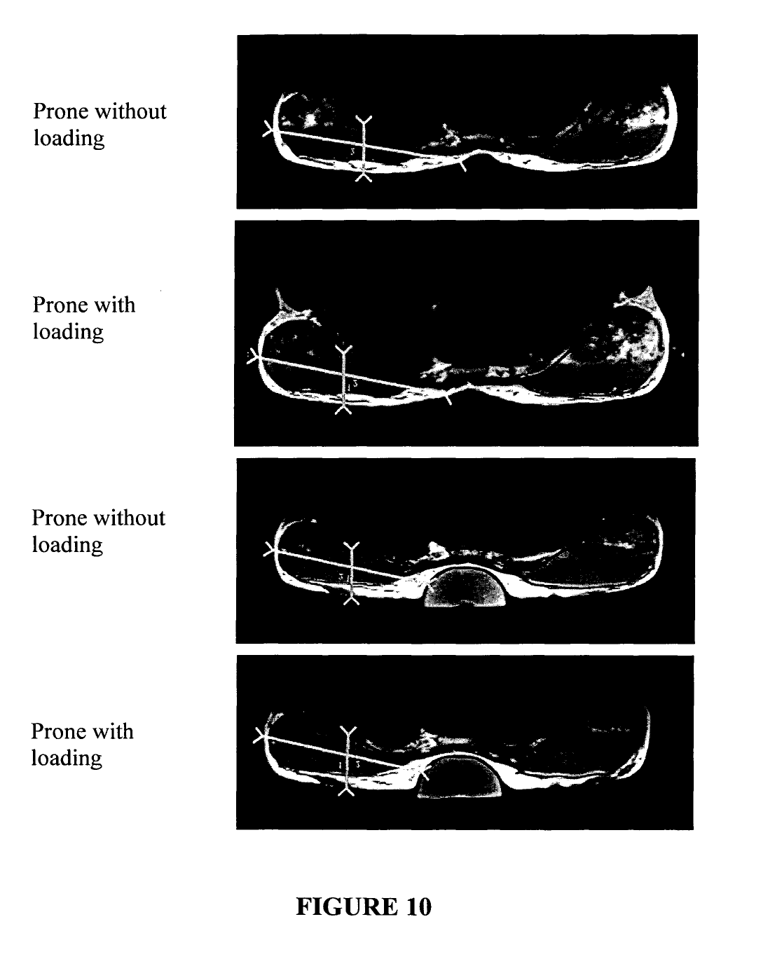

For subjects with natural unaltered breasts, an approximately 45% reduction in AP compression and an about 28% reduction in ML displacement was observed in the presence of the device as illustrated in FIG. 9. For subject LA, having EE cupsize with silicon implant, an about 12% reduction in AP compression and an about 14% reduction in ML displacement were observed in the presence of the device (see FIG. 10).

Many modifications will be apparent to those skilled in the art without departing from the scope of the present invention.

The disclosure of every patent, patent application, and publication cited herein is hereby incorporated herein by reference in its entirety.

TABLE 1

| | Condition (all data from | Max force | Peak pressure | |
|---|---|---|---|---|
| Subject | right breast) | (N) | (kPa) | |
| LI | No pad, no weight | 58.8N | 11.5 | kPa |
| | Pad, no weight | 29.3N | 7.3 | kPa |
| | No pad plus 15 kg | 70.9N | 12.3 | kPa |
| | Pad plus 15 kg | 34.4N | 8 | kPa |
| | No manip data | | | |
| J | No pad, no weight | 54.4N | 12.8 | kPa |
| | Pad, no weight | 24.2N | 9.3 | kPa |
| | No pad plus 15 kg | 69.7N | 12.5 | kPa |
| | Pad plus 15 kg | 21.2N | 7.8 | kPa |
| | Manip with pad* | 79.4N | 15.8 | kPa |
| | Manip without pad* | 186N | 32.5 | kPa |
| S | No pad, no weight | 25.5N | 8 | kPa |
| | Pad, no weight | 3.3N | 4.5 | kPa |
| | No pad plus 15 kg | 35N | 10 | kPa |
| | Pad plus 15 kg | 11N | 5.5 | kPa |
| | Manip with pad* | 55N | 12 | kPa |
| | Manip without pad* | 128N | 38.5 | kPa |
| LA | No pad, no weight | 25.2N | 7.5 | kPa |
| | Pad, no weight | 0.8N | 4 | kPa |
| | No pad plus 15 kg | 49.2N | 10.25 | kPa |
| | Pad plus 15 kg | 6.8N | 6 | kPa |
| | Manip with pad* | 45.5N | 11.5 | kPa |
| | Manip without pad* | 130.1N | 36 | kPa |
| C | No pad, no weight | 32.4N | 10 | kPa |
| | Pad, no weight | 1.3N | 4.3 | kPa |
| | No pad plus 15 kg | 51.9N | 13.8 | kPa |
| | Pad plus 15 kg | 2.5N | 4.3 | kPa |
| | Manip with pad* | 26.1N | 10.8 | kPa |
| | Manip without pad* | 135.6N | 38.3 | kPa |

1. An orthosis for placing on a supporting surface to lie adjacent the breasts of a subject lying prone on the surface, the orthosis comprising:
(a) a central portion extending along a longitudinal axis of the orthosis to be receivable between the breasts of the subject to support the sternum; and
(b) opposed portions extending bilaterally outwardly from a cephalad end of the central portion to support the clavicle and/or upper ribcage/costal cartilage (“cephalad portions”); and/or
(c) opposed portions extending bilaterally outwardly from a caudal end of the central portion to support the lower ribcage/costal cartilage and/or upper abdomen (“caudal portions”),
the portions being configured such that spaces are defined laterally outward of the longitudinal axis and the breasts are displaced laterally and/or superolaterally to occupy the spaces.

2. An orthosis according to claim 1, including the caudal portions.

3. An orthosis according to claim 2, wherein adjacent edge portions of the central and caudal portions form curves which define laterally inner caudal boundaries of the spaces.

4. An orthosis according to claim 2, configured with a relief between the caudal portions to limit or eliminate pressure on the xiphoid process.

5. An orthosis according to claim 2, wherein the caudal portions are configured to contact the subject along axes which are divergent about the longitudinal axis in a caudal direction, each of which axes forms an angle of between about 70° and about 80°.

6. An orthosis according to claim 2, wherein the caudal portions are upwardly convex as viewed in section orthogonal to lines along which they engage the subject.

7. An orthosis according to claim 1, including the cephalad portions.

8. An orthosis according to claim 7, wherein adjacent edge portions of the central and cephalad portions form curves which define laterally inner cephalad boundaries of the spaces.

9. An orthosis according to claim 7, configured with a relief between the cephalad portions to limit or eliminate pressure on the trachea and/or jugular notch to facilitate breathing.

10. An orthosis according to claim 8, wherein the cephalad portions are configured to contact the subject along axes which are divergent about the longitudinal axis in a cephalad direction, each of which axes forms an angle of between about 55° and about 65°.

11. An orthosis according to claim 7, wherein the cephalad portions are upwardly convex as viewed in section orthogonal to lines along which they engage the subject.

12. An orthosis according to claim 1, which opens bilaterally outwardly of the central portion to be of a generally I-shaped configuration.

13. An orthosis according to claim 1, being configured to deform resiliently when engaged by the subject.

14. An orthosis according to claim 13, formed with at least one cavity disposed below an exterior surface of the orthosis which surface is exposed when the orthosis is placed on the supporting surface, the cavity or cavities being located at a position which underlies the xiphoid process when the orthosis is engaged by the subject, to promote deformation of the orthosis at that position.

15. A method of supporting the upper torso of a subject lying prone against a supporting surface comprising positioning an orthosis according to claim between the subject and the supporting surface to lie adjacent the breasts of the subject, such that the central portion supports the sternum and the opposed portions support the clavicle and/or upper ribcage/costal cartilage and/or the lower ribcage/costal cartilage and/or upper abdomen, whereby the breasts are displaced laterally and/or superolaterally to occupy the spaces.
